(19) United States
(12) Patent Application Publication
(10) Pub. No.: US 2018/0150378 A1
(43) Pub. Date: May 31, 2018

(54) VERIFICATION OF MODEL-DRIVEN SOFTWARE ARCHITECTURE

(71) Applicants: Swaminathan Gopalswamy, Novi, MI (US); Daniel Ratiu, München (DE); Sundaresan Sorakayalpet Arumugam, Chennai (IN)

(72) Inventors: Swaminathan Gopalswamy, Novi, MI (US); Daniel Ratiu, München (DE); Sundaresan Sorakayalpet Arumugam, Chennai (IN)

(21) Appl. No.: 15/364,333

(22) Filed: Nov. 30, 2016

(51) Int. Cl. G06F 11/36; G06F 9/44

(52) U.S. Cl. CPC G06F 11/3608; G06F 8/35

(57) ABSTRACT

A method and system for verifying model-driven software architecture in an integrated-development environment is disclosed. In one embodiment, a method of verifying model-driven software architecture in an integrated-development environment includes generating the model-driven software architecture including a plurality of elements and connections between the elements. Each element consists of at least one of an input, an output, and a parameter. The method includes deriving contracts associated with the model-driven software architecture and its elements based on at least one of the input, the output, and the parameter associated with said each element. Furthermore, the method includes generating programming language statements based on the contracts associated with the model-driven software architecture and its elements and the connections between the elements. Moreover, the method includes verifying the contracts associated with the model-driven software architecture and its elements using the programming language statements.

### FIELD OF TECHNOLOGY

The present disclosure generally relates to the field of model-driven software development, and more particularly relates to method and system for verifying model-driven software architecture in an integrated-development environment.

### BACKGROUND

An integrated-development environment (IDE) is a software application that provides comprehensive facilities to software engineers for software development. Some integrated-development environments enable development of software using formal structured, top-down development approaches such as model-driven software development. Based on the model-driven software development approach, software engineers may use an integrated-development environment to generate model-driven software architecture. The model-driven software architecture typically consists of different elements (i.e., instances of block interfaces), wherein specifications are assigned to each of the elements.

Based on the model-driven software architecture, software engineers implement each of the elements, assemble the elements to form a system of assembled elements and generate test cases to verify whether the system of assembled elements would satisfy the specifications. If the system of assembled elements does not satisfy the specifications, the software engineers may further analyze and identify elements which are preventing the system from satisfying the specification. In case, such elements are found, the software engineers may have to amend the specifications of the identified elements in the model-driven software architecture, modify the implementation based on the amended specification and run the tests till the elements as well as the system of assembled components are found to be conforming to the specifications. This may be iterative, time consuming and cumbersome activity. Also, the process of verification may be error-prone especially when test cases fail to capture a scenario in which one or more elements or the system of assembled elements may not satisfy its specification in real-time.

### SUMMARY

A method and system for verifying model-driven software architecture in an integrated-development environment is disclosed. In one aspect, a computer-implemented method of verifying a model-driven software architecture in an integrated-development environment includes generating the model-driven software architecture with a plurality of elements and connections between the elements. Each element consists of at least one of an input, an output, and a parameter. The method also includes deriving contracts associated with the model-driven software architecture and its elements based on at least one of the input, the output, and the parameter associated with said each element. Furthermore, the method includes generating programming language statements based on the contracts associated with the model-driven software architecture and its elements and the connections between the elements. Moreover, the method includes verifying the contracts associated with the model-driven software architecture and its elements using the programming language statements.

In another aspect, a data processing system includes a processing unit, and a memory coupled to the processing unit. The memory includes a model-driven development module configured to generate a model-driven software architecture including a plurality of elements and connections between the elements. Each element consists of at least one of an input, an output, and a parameter. The model-driven development module is configured to derive contracts associated with the model-driven software architecture and its elements based on at least one of the input, the output, and the parameter associated with said each element. The model-driven development module is configured to generate programming language statements based on the contracts associated with the model-driven software architecture and its elements, and connections between the elements. The model-driven development module is configured to verify the contracts associated with the model-driven software architecture and its elements using the programming language statements.

In yet another aspect, a non-transitory computer-readable storage medium, having instructions stored therein, which when executed by a data processing system, cause the data processing system to perform a method of verifying a model-driven software architecture in an integrated-development environment described above.

This summary is provided to introduce a selection of concepts in a simplified form that are further described below in the following description. It is not intended to identify features or essential features of the claimed subject matter. Furthermore, the claimed subject matter is not limited to implementations that solve any or all disadvantages noted in any part of this disclosure.

### BRIEF DESCRIPTION OF THE VIEWS OF THE DRAWINGS

A more complete appreciation of the present disclosure and many of the attendant aspects thereof will be readily obtained as the same becomes better understood by reference to the following description when considered in connection with the accompanying drawings:

FIG. 1 illustrates a block diagram of a data processing system in which an embodiment can be implemented;

FIG. 2 is a block diagram illustrating various modules of a model-driven development module of FIG. 1, according to an embodiment;

FIG. 3 illustrates a process flowchart of an exemplary method of verifying model-driven software architecture in an integrated-development environment, according to an embodiment;

FIG. 4 illustrates a block diagram of another data processing system in which an embodiment can be implemented;

FIG. 5 is a schematic representation of an exemplary model-driven software architecture for a cruise control system of a vehicle;

FIG. 6A is a tabular representation of an exemplary contract database such as those shown in FIG. 1;

FIG. 6B is a tabular representation of a data dictionary for deriving contracts corresponding to the model-driven software architecture and its elements; and

FIG. 7 illustrates a screenshot view of an output of verification of the model-driven software architecture of FIG. 5.

### DETAILED DESCRIPTION

A method and system for verifying model-driven software architecture in an integrated-development environment is disclosed. Various embodiments are described with reference to the drawings, wherein like reference numerals are used to refer to like elements throughout. In the following description, numerous specific details are set forth in order to provide thorough understanding of embodiments of the present disclosure. It will be apparent to one skilled in the art, that these specific details need not be employed to practice embodiments of the present disclosure. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the present disclosure.

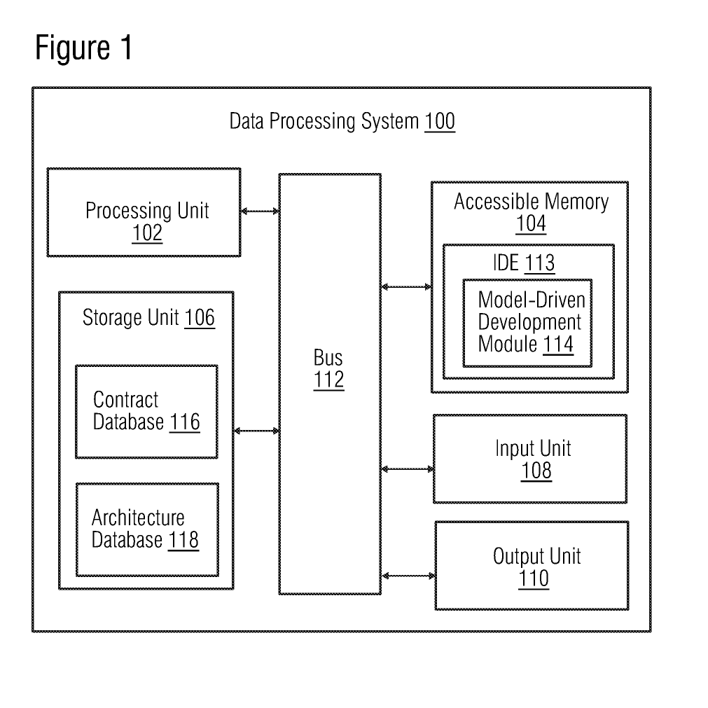

FIG. 1 illustrates a block diagram of a data processing system 100 in which an embodiment can be implemented, for example, as a data processing system particularly configured by software or otherwise to perform the processes as described herein. The data processing system 100 may be a personal computer, a laptop computer, a tablet, smart phone, and the like. In FIG. 1, the data processing system 100 includes a processing unit 102, an accessible memory 104, a storage unit 106, an input unit 108, an output unit 110, and a bus 112.

The processing unit 102, as used herein, means any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 102 may also include embedded controllers, such as generic or programmable logic devices or arrays, application specific integrated circuits, single-chip computers, and the like.

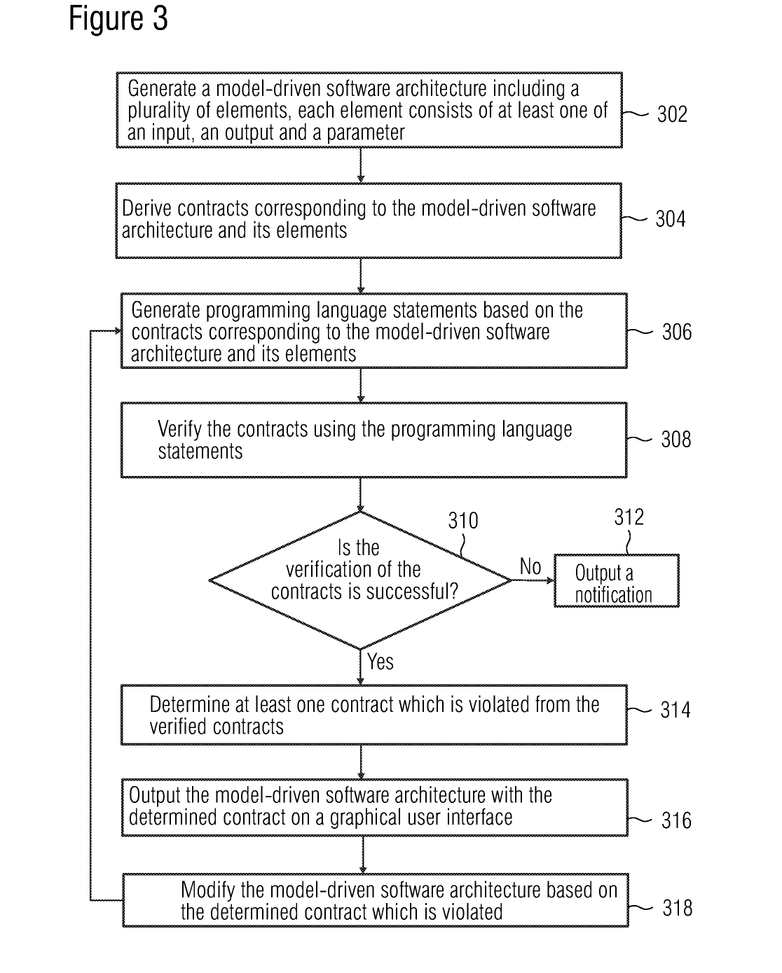

The memory 104 may be volatile memory and non-volatile memory. The memory 104 may be coupled for communication with the processing unit 102. The processing unit 102 may execute instructions and/or code stored in the memory 104. A variety of computer-readable storage media may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 104 includes an integrated-development environment (IDE) 113. The IDE 113 includes a model-driven development module 114 stored in the form of machine-readable instructions on any of the above-mentioned storage media and may be in communication to and executed by processing unit 102. When executed by the processing unit 102, the model-driven development module 114 causes the processing unit 102 to generate a model-driven software architecture having a plurality of elements, derive and verify contracts corresponding to a model-driven software architecture and its elements, and determine one or more contracts which are violated from the derived contracts. Additionally, the model-driven development module 114 causes the processing unit 102 to modify the model-driven software architecture and associated contracts based on the contracts that are violated. Method steps performed by the processing unit 102 to achieve the above functionality are described in greater detail in FIG. 3.

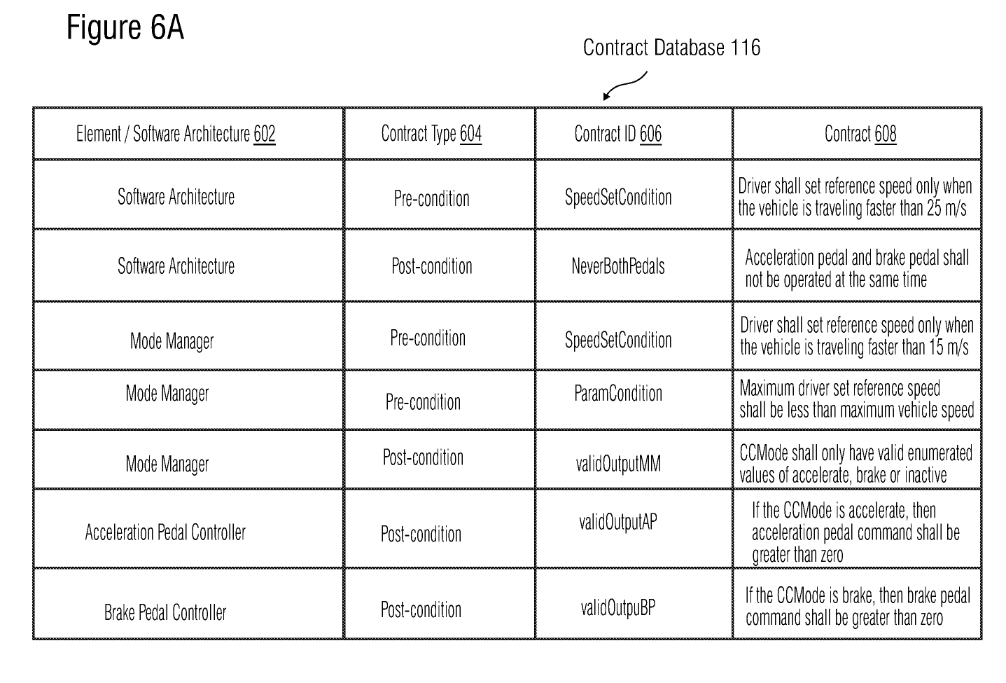

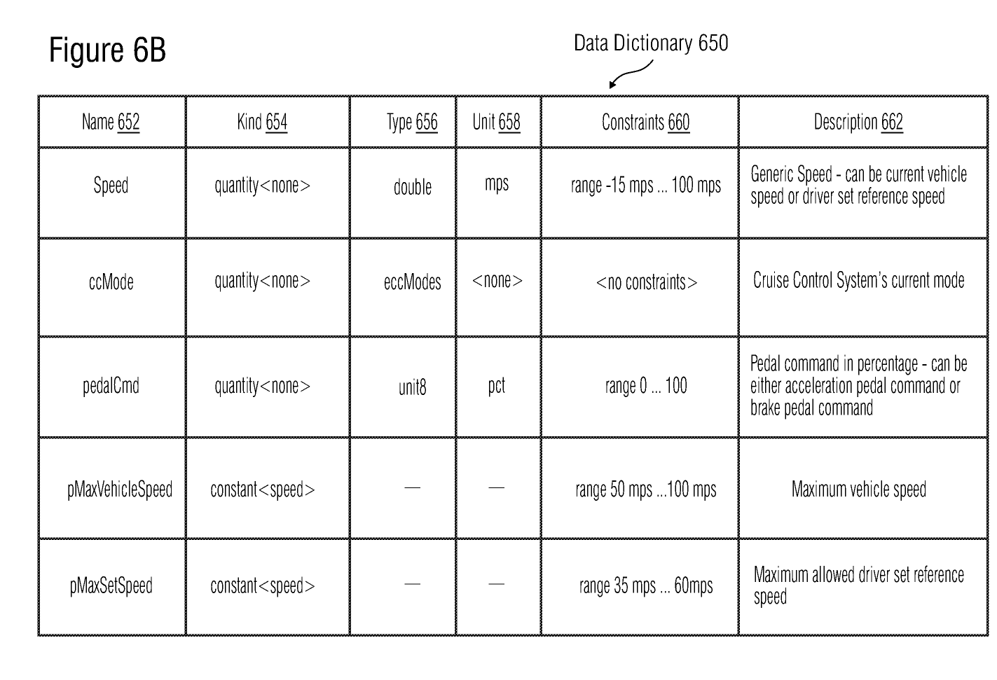

The storage unit 106 may be a non-transitory storage medium which stores a contract database 116 and an architecture database 118. The contract database 116 stores a plurality of contracts corresponding to the model-driven software architecture and its elements. Exemplary representation of the contract database 116 for a cruise control system is illustrated in FIG. 6A. The contracts database 116 also stores a data dictionary which contains properties linked to inputs, outputs and parameters associated with the model-driven software architecture and its elements. The data dictionary helps in deriving the contracts corresponding to the model-driven software architecture and its elements. Exemplary data dictionary is illustrated in FIG. 6B. The architecture database 118 stores information associated with the model-driven software architecture. For example, the information associated with the model-driven software architecture may include information associated with the elements such as inputs, outputs, and parameters associated with each of the elements, connections between the elements, specifications and so on.

The input unit 108 may include input means such as keypad, touch-sensitive display, camera (such as a camera receiving gesture-based inputs), etc. capable of receiving input signal such as user commands to generate and verify model-driven software architecture in the IDE 113 and to modify the model-driven software architecture and associated contracts based on the contracts which are violated. The output unit 110 may be means for displaying a graphical user interface which visualizes the model-driven software architecture indicating the elements whose the contracts are violated. The output unit 110 also provides a graphical user interface which enables to interact with the IDE 113. The bus 112 acts as interconnect between the processing unit 102, the memory 104, the storage unit 106, the input unit 108, and the output unit 110.

Those of ordinary skilled in the art will appreciate that the hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and/or an event such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

Disclosed embodiments provide systems and methods that verify model-driven software architecture in an integrated-development environment. In particular, disclosed techniques may generate model-driven software architecture including elements and connections between the elements, derive contracts corresponding to the model-driven software architecture and its elements, generate programming language statements based on the contracts and the connection between the elements, and determine one or more contracts which are violated using programming language statements.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system 100 may conform to any of the various current implementation and practices known in the art.

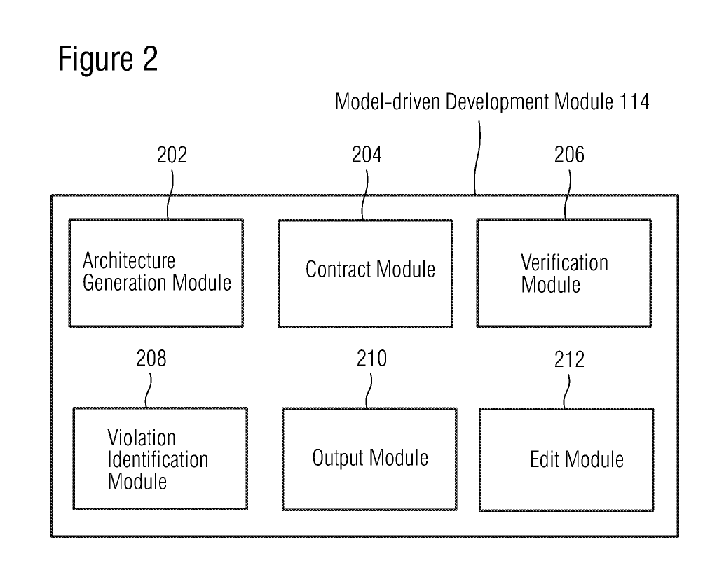

FIG. 2 is a block diagram illustrating various modules of the model-driven development module 114, according to an embodiment. As shown in FIG. 2, the model-driven development module 114 includes an architecture generation module 202, a contract module 204, a verification module 206, a violation identification module 208, an output module 210, and an edit module 212.

The architecture generation module 202 is configured to generate a model-driven software architecture in the IDE 113. In some embodiments, the architecture generation module 202 may be configured to generate model-driven software architecture for an embedded system. The model-driven software architecture may include one or more elements that are assigned particular functions. For example, consider the embedded system to be a cruise control system for a vehicle having three subsystems, i.e., mode manager, brake pedal controller, and accelerator pedal controller. The cruise control system needs to ensure that acceleration pedal and brake pedal are not operated at the same time during cruise control mode of the vehicle. The mode manager determines whether the vehicle needs to accelerate or apply brake and accordingly outputs a mode so that current vehicle speed matches a driver set reference speed. Based on the mode, the acceleration pedal controller and the brake pedal controller outputs an acceleration pedal command and a brake pedal command respectively.

In the above example, the model-driven software architecture may include three elements: mode manager, brake pedal controller, accelerator pedal controller. Each element is assigned an input(s), a parameter(s) and/or an output(s). The inputs, outputs and parameters are linked to a data dictionary containing range properties (e.g., constraint values) corresponding to the inputs, outputs and parameters. For example, inputs for the mode manager may be ‘driver set reference speed’ and ‘vehicle speed’, parameters may be ‘maximum vehicle speed’ and ‘maximum driver set reference speed’, and output may be ‘CCmode’. Similarly, the model-driven software architecture may contain inputs and outputs. The model-driven software architecture is generated based on architecture definition languages such as Unified Markup Language (UML), Systems Modelling Language (SysML), Architecture Analysis and Design Language (AADL), etc.

The contract module 204 derives contracts corresponding to the model-driven software architecture and each of the elements based on respective contract templates. A contract may include pre-condition or post-condition which specify constraints. The pre-condition specify constraints involving inputs and parameters of the model-driven software architecture and its elements, while the post-condition specify constraints involving outputs in terms of the inputs and the parameters. For example, a contract template for the element ‘mode manager’ may include pre-conditions as ‘maximum driver set reference speed is always less than maximum vehicle speed’ and ‘driver reference speed is only set when vehicle speed is higher than some value’. In such case, the contract module 204 refers to the data dictionary associated with the cruise control system and determines range properties corresponding to the input, the output and the parameters associated with the mode manager. Accordingly, the derived contract may have the pre-conditions which state that driver set reference speed is always greater than or equal to −15 m/s and less than or equal to 100 m/s.

The verification module 206 is configured to automatically generate programming language statements based on the contracts corresponding to the model-driven software architecture and its elements, and connections between the elements. The verification module 206 is configured to verify the contracts using the programming language statements. The verification module 206 may verify the contracts associated with each of the elements and the model-driven software architecture in a sequential order or in parallel. For each element and the model-driven software architecture as a whole, programming language statements corresponding to one or more contracts are posited as true while the programming language statements corresponding to the remaining contracts are posited as statements not to be reached.

In some embodiments, the verification module 206 parses the programming language statements using a parser and generates a control flow graph based on the parsed programming language statements. In these embodiments, the verification module 206 determines whether any of the contracts are violated using the control flow graph, i.e., the statements corresponding to the contracts posited as not to be reached as reached. In an exemplary implementation, the programming language statements are written in ‘C’ programming language. In such implementation, the verification module 206 traverses through the control flow graph using a C-model checker and determines the C statements which correspond to violation of the contracts. The C-model checker uses a decision procedure to traverse through the control flow graph and identify paths that lead to violations of the contracts. The decision procedure may employ a bit-vector logic including non-linear arithmetic and arrays to solve reachability of paths represented as a Boolean satisfiability problem.

The violation identification module 208 is configured to determine whether the verification of the contracts is successful. The violation identification module 208 is configured to determine one or more contracts which are violated if the verification of the contracts is unsuccessful. The violation identification module 208 determines whether the pre-condition or the post-condition of the contract is violated. Based on which, the violation identification module 208 determines the contract as being violated. Furthermore, the violation module 208 determines one or more elements whose corresponding contract is violated. For example, the violation identification module 208 may identify the mode manager as an element whose contract is violated if the pre-condition or the post-condition of the contract are violated.

The output module 210 is configured to output the model-driven software architecture with one or more contracts which are violated on a graphical user interface of the output unit 110. For example, the output module 210 may display the mode manager as erroneous element along with the pre-conditions and/or the post-conditions of the associated contracts which are violated in an interface associated with the IDE 113. The edit module 212 is configured to modify the model-driven software architecture and the associated contracts based on the contracts which are violated. For example, the edit module 212 may enable software engineers to modify the inputs, the output, and/or the parameters, and the contracts associated with the mode manager via the interface associated with the IDE 113.

FIG. 3 illustrates a process flowchart 300 of an exemplary method of verifying model-driven software architecture in the IDE 113, according to an embodiment. At step 302, a model-driven software architecture including a plurality of elements is generated in the IDE 113. Each of the elements consists of at least one of an input, an output and a parameter. At step 304, contracts corresponding to the model-driven software architecture and its elements are derived based on the input, the output and/or the parameter of said each of the elements. For example, the contracts contain pre-conditions and post-conditions which specify constraints that need to be satisfied. The pre-conditions and the post-conditions may also be derived based on properties defined in a data dictionary associated with the model-driven software architecture.

At step 306, programming language statements are generated based on the contracts associated with the model-driven software architecture and its elements and connections between the elements. For example, statements in C programming language are generated based on the pre-conditions and the post-conditions in the contracts. Also, statements in the C programming language may be generated based on inputs, outputs and parameters of the elements and connections between the elements. At step 308, the contracts corresponding to the model-driven software architecture and its elements are verified using the programming language statements. For example, the C statements are parsed using a parser. Thereafter, a control flow graph is generated based on the parsed C statements. It is determined whether any of the pre-conditions and the post-conditions corresponding to the contracts are violated by traversing through the control flow graph using a C model checker.

At step 310, it is determined whether the verification of the contracts associated with model-driven software architecture and its elements is successful. If the verification is successful, then at step 312, a notification indicating the model-driven architecture is successful verified is displayed on the output unit 110. Upon successful verification, software engineers may implement the elements in the model-driven software architecture, assemble the implemented elements to form a system of assembled elements and test the system of assembled elements.

If the verification is unsuccessful, then at step 314, at least one contract which is violated is determined. For example, a contract whose pre-condition or post-condition is not satisfied is identified from the contracts. At step 316, the model-driven software architecture with the determined contract which is violated is outputted on a graphical user interface of the output unit 110. For example, verifications status with respect to each element and the associated pre-condition or post-condition that is violated is displayed on the output unit 110. At step 318, the model-driven software architecture is modified based on the determined contract which is violated. For example, the input, the output and/or the parameter associated with the element that is causing the contract to be violated and the violated contract are modified. The process 300 is then routed to step 306 and the steps 306 to 310 are performed.

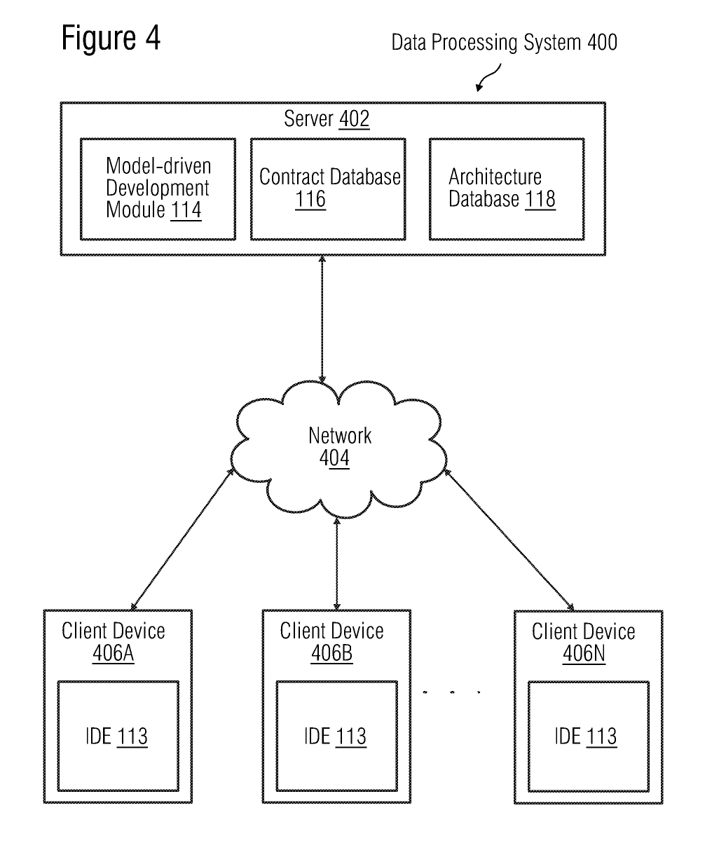

FIG. 4 illustrates a block diagram of another data processing system 400 in which an embodiment can be implemented. Particularly, the data processing system 400 includes a server 402 and a plurality of client devices 406A-N. Each of the client devices 406A-N is connected to the server 402 via a network 404 (e.g., Local Area Network (LAN), Wide Area Network (WAN), Wi-Fi, etc.). The data processing system 400 is another implementation of the data processing system 100 of FIG. 1, wherein the model-driven development module 114 resides in the server 402 and is accessed by client devices 406A-N via the network 404.

The server 402 includes the model-driven development module 114, the contract database 116, and the architecture database 118. The server 402 may also include a processing unit, a memory, and a storage unit. The model-driven development module 114 may be stored on the memory in the form of machine-readable instructions and executable by the processing unit. The contract database 116 and the architecture database 118 may be stored in the storage unit. The server 402 may also include a communication interface for enabling communication with client devices 406A-N via the network 404.

When the machine-readable instructions are executed, the model-driven development module 114 causes the server 402 to generate model-driven software architecture having a plurality of elements and connection between the elements, derive contracts corresponding to the model-driven architecture and its elements, generate programming language statements based on the contracts and the connections between the elements, verify the contracts using corresponding programming language statements, and determine the contracts which are violated. Method steps performed by the server 402 to achieve the above-mentioned functionality are described in greater detail in FIGS. 2 and 3. The client devices 406A-N include the integrated-development environment (IDE) 113 which enable software engineers to access the model-driven development module 114 in the server 402 to generate and verify the model-driven software architecture in the manner described above.

One can envision that, the model-driven development module 114 may reside in a cloud server in a cloud computing environment, wherein the client devices 406A-N connected via a cloud network may access the model-driven development module 114 to automatically verify the model-driven software architecture using contracts.

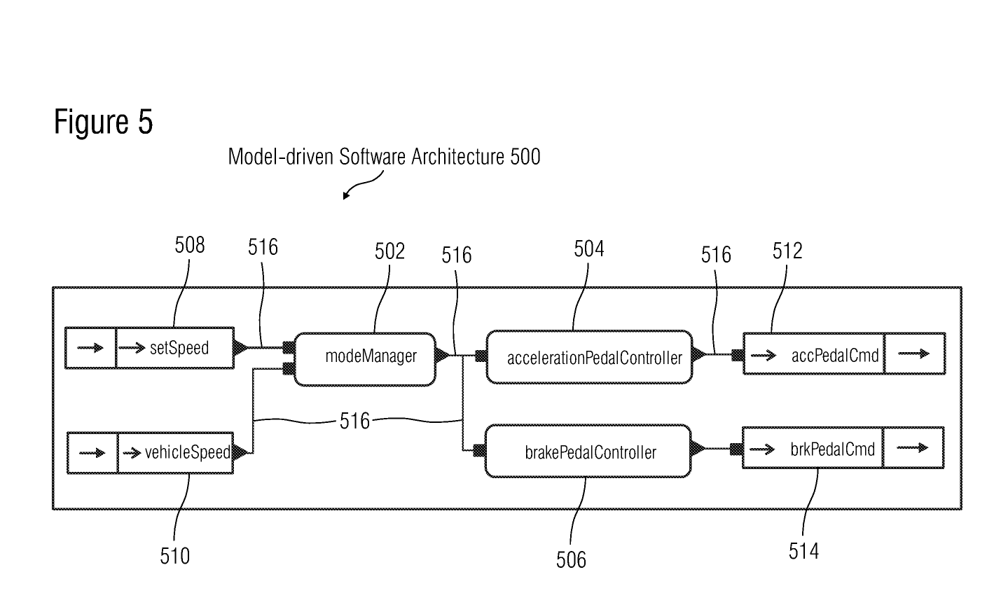

FIG. 5 is a schematic representation of an exemplary model-driven software architecture 500 for a cruise control system of a vehicle. The cruise control system is to be configured to ensure that an acceleration pedal and a brake pedal are not operated at the same time. As depicted, the model-driven software architecture 500 includes three instances of block interfaces (also referred as elements) 502 to 506 and connections between the instances of block interfaces 516. The instances of block interfaces include a mode manager 502, an acceleration pedal controller 504, and a brake pedal controller 506. The mode manager 502 determines whether the vehicle needs to accelerate or decelerate so that the vehicle speed matches the driver set reference speed. The mode manager 502 outputs a mode which indicates whether the vehicle can accelerate or apply brakes or remain inactive. The acceleration pedal controller 504 receives the mode from the mode manager 502 and outputs the acceleration pedal command. For example, if the mode is accelerate, then the acceleration pedal command is greater than zero. The brake pedal controller 506 receives the mode from the mode manager 502 and outputs a brake pedal command. For example, if the mode is brake, then the brake pedal command is greater than zero.

The model-driven software architecture 500 has inputs 508 and 510 and outputs 512 and 514. For example, the inputs 508 and 510 correspond to driver set reference speed and current vehicle speed respectively whereas the outputs 512 and 514 correspond to acceleration pedal command and brake pedal command respectively. Similarly, each instance of the block interfaces has input(s), output(s), and/or parameter(s). For example, the mode manager 502 is having driver set reference speed 508 and vehicle current speed 510 as inputs, CCmode as output, and maximum driver set reference speed and maximum vehicle speed as parameter.

FIG. 6A is a tabular representation of an exemplary contract database 116 such as those shown in FIG. 1. Particularly, FIG. 6A depicts the contract database 116 which stores contract templates associated with the model-driven software architecture 500 and its elements 502 to 506. The contract database 116 includes an element/software architecture field 602, a contract type field 604, a contract ID field 606, and a contract field 608.

The element/software architecture field 602 indicates whether contract is associated with a specific element (e.g., mode manager) or the model-driven software architecture 500. For example, the element/software architecture field 602 indicates contracts that are associated with the model-driven software architecture 500, the mode manager 502, the acceleration pedal controller 504, and the brake pedal controller 506. The contract type field 604 indicates whether a specific contract type is a pre-condition or post-condition. The model-driven software architecture 500 and its elements 502 to 506 may be associated with a pre-condition(s) and/or a post-condition. As shown in FIG. 6A, the model-driven software architecture 500 have one pre-condition and one post-condition whereas the mode manager 502 have two pre-conditions and one post-condition.

The contract ID field 606 indicates a contract identifier associated with the contract type. The contract identifier further defines the contract type. The contract field 608 describes each of the contracts corresponding to the model-driven software architecture 500 and its elements 502 to 506. For example, for the contract type ‘pre-condition’ corresponding to the model-driven software architecture 500, the contract field 608 states that ‘driver shall set a reference speed only when the vehicle is travelling faster than 25 m/s’. This means that the driver is not allowed to set the reference speed if the vehicle is travelling at a speed less than 25 m/s according to the contract.

FIG. 6B is a tabular representation of an exemplary data dictionary 650 for deriving contracts corresponding to the model-driven software architecture 500 and its elements 502-506. The data dictionary 650 contains range properties that the model-driven software architecture 500 has to satisfy prior to implementing the elements of the model-driven software architecture 500. As shown in FIG. 6B, the data dictionary 650 contains a name field 652, a kind field 654, a type field 656, a unit field 658, a constraints field 660 and description field 662. The name field 652 indicates name of inputs 508 and 510 and outputs 512 and 514 of the model-driven software architecture 500. For example, the name field 652 indicates name of input 508 as ‘speed’. The corresponding values in the fields 654 to 662 refer to the data in the name field 652. The kind field 654 indicates kind associated with names in the name field 652. The type field 656 indicates data type associated with the names in the name field 654. The unit field 658 indicates physical units associated with the names in the name field 652. For example, physical unit associated with the set speed is ‘m/s’.

The constraints field 660 indicates constraints associated with values in the name field 652. For example, the constraint field 660 indicates range associated with the speed as ‘15 m/s to 100 m/s’. That is, the speed shall be between 15 m/s to 100 m/s. The description field 662 defines the corresponding names in the name field 652. For example, the name ‘speed’ is defined as ‘Current vehicle speed’ or ‘driver set reference speed’ in the description field 662. Similarly, the names ‘pMaxVehicleSpeed’ and ‘pMaxSetSpeed’ are respectively defined as ‘maximum vehicle speed’ and ‘maximum allowed driver set reference speed’ in the description field 662.

According to the present disclosure, the data processing system 100 refers the data dictionary 650 to derive the contracts corresponding to the model-driven software architecture 500 of the cruise control system and its elements (e.g., mode manager 502, acceleration pedal controller 504, and brake pedal controller 506) based on the contract templates stored in the contract database 116 using the data dictionary 650. This is possible as the inputs 508 and 510, the outputs 512 and 514 and parameters are linked to corresponding entries in the data dictionary 650. For example, the inputs 508 and 510 (‘vehicle speed’ and ‘driver set reference speed’) is linked to an entry ‘speed’ in the data dictionary 650. Similarly, the outputs 512 and 514 (‘acceleration pedal command’ and ‘brake pedal command’) are linked to an entry ‘pedal command’ in the data dictionary 650. The parameters associated with the mode manager 502 are linked to entries ‘pMaxVehicleSpeed’ and ‘pMaxSetSpeed’.

The data processing system 100 refers to the data dictionary 650 and finds out range properties defined in the constraint field 660 for the name ‘speed’ in the name field 652 as the entry ‘speed’ is linked to the inputs to the mode manager 502. For example, the pre-condition for the mode manager 502 includes the conditions that ‘setSpeed’ shall be greater than or equal to −15 m/s and less than or equal to 100 m/s and that ‘vehicleSpeed’ shall be greater than or equal to −15 m/s and less than or equal to 100 m/s. The data processing system 100 also finds out range properties in the constraint field 660 with respect to ‘pMaxVehicleSpeed’ and ‘pMaxSetSpeed’ in the name field 652. In this example, the pre-condition for the mode manager 502 includes the conditions that maximum vehicle speed shall be greater than or equal to 50 m/s and less than or equal to 100 m/s and that maximum driver set reference speed shall be greater than or equal to 35 m/s and less than or equal to 60 m/s.

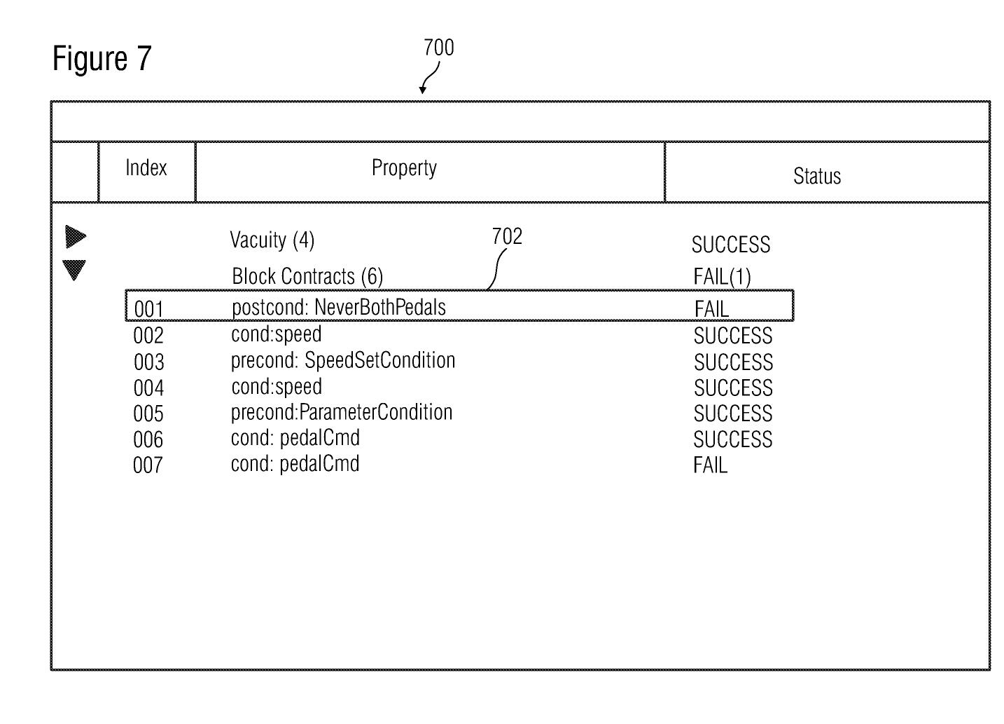

FIG. 7 illustrates a screenshot view 700 of an output indicating the contracts which are violated based on verification of the model-driven software architecture 500. As depicted, the screenshot view 700 indicates a verification status of the contracts corresponding to the model-driven software architecture 500 and its elements 502 to 506. For example, the screenshot view 700 displays that a verification status 702 of the post-condition ‘both pedal commands never non-zero’ associated with the model-driven software architecture 500 is equal to ‘FAIL’ as the post-condition of the contract (i.e., both pedals are never greater than zero at the same time) is violated.

The verification of the model-driven software architecture is unsuccessful as the elements do not guarantee that the cruise control system's responsibility to ensure that the brake pedal and the accelerator pedal are not issued commands at the same instance is met. This is because the specification for the acceleration pedal command and the brake pedal command mentions that if the mode is accelerate, the acceleration pedal command should be greater than zero or if the mode is brake, the brake pedal command should be greater than zero. This does not preclude the possibility that if the mode is not accelerate, the acceleration pedal command is greater than zero or if the mode is not brake, the brake pedal command is greater than zero.

In various embodiments, the systems and methods shown in FIGS. 1 to 7 automatically verifies consistency and correctness of a model-driven software architecture using the contracts derived for the model-driven software architecture and its elements. That is, the systems and methods checks whether specifications written for the elements of the model-driven software architecture are compatible with each other and ensure that expected output be achieved (e.g., brake pedal and accelerator pedal not operated at same time). The systems and methods use programming language statements which are verified using a model checker to determine contracts that are violated. Also, the systems and methods enable software engineers to automatically identify errors in the model-driven software architecture prior to implementation and fix the errors in the model-driven software architecture. This saves time and efforts to test the implementation of the model-driven software architecture, modify the model-driven software architecture and re-implement its elements. The systems and methods output the contracts associated with the model-driven software architecture and its elements which are violated and enable software engineers to modify the erroneous model-driven software architecture.

It is to be understood that the system and methods described herein may be implemented in various forms of hardware, software, firmware, special purpose processors, or a combination thereof. One or more of the present embodiments may take a form of a computer program product including program modules accessible from computer-usable or computer-readable medium storing program code for use by or in connection with one or more computers, processors, or instruction execution system. For the purpose of this description, a computer-usable or computer-readable medium can be any apparatus that can contain, store, communicate, propagate, or transport the program for use by or in connection with the instruction execution system, apparatus, or device. The medium can be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and digital versatile disc (DVD). Both processors and program code for implementing each aspect of the technology can be centralized or distributed (or a combination thereof) as known to those skilled in the art.

While the present disclosure has been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope.

What is claimed is:

1. A computer-implemented method of verifying a model-driven software architecture in an integrated-development environment, comprising:
generating, using a data processing system, the model-driven software architecture comprising a plurality of elements and connections between the elements, each element consists of at least one of an input, an output, and a parameter;
deriving contracts associated with the model-driven software architecture and its elements based on at least one of the input, the output, and the parameter associated with said each element;
generating programming language statements based on the contracts associated with the model-driven software architecture and its elements and the connections between the elements; and
verifying the contracts associated with the model-driven software architecture and its elements using the programming language statements.

2. The method of claim 1, wherein the at least one contract comprises a pre-condition or a post-condition which specify constraints to be satisfied.

3. The method of claim 1, further comprising:
determining whether the verification of the contracts associated with the model-driven software architecture and its elements is successful; and
if the verification is unsuccessful, determining at least one contract which is violated.

4. The method of claim 3, further comprising:
outputting the model-driven software architecture with the at least one contract which is violated on the graphical user interface.

5. The method of claim 4, further comprising:
modifying the model-driven software architecture based on the contracts that are violated.

6. The method of claim 1, wherein verifying the contracts associated with the model-driven software architecture and its elements using the programming language statements comprises:
parsing the programming language statements;
generating a control flow graph based on the parsed programming language statements; and
determining whether any of the contracts are violated using the control flow graph.

7. The method of claim 1, wherein deriving the contracts associated with the model-driven software architecture and its elements comprises:
deriving the contracts associated with the model-driven software architecture and its elements using a data dictionary, wherein the input, the output, and the parameter of said each element are linked to entries in the data dictionary.

8. A data processing system comprising:
a processing unit; and
a memory coupled to the processing unit, wherein the memory comprises an model-driven development module configured to:
generate a model-driven software architecture comprising a plurality of elements and connections between the elements, each element consists of at least one of an input, an output, and a parameter;
derive contracts associated with the model-driven software architecture and its elements based on at least one of the input, the output, and the parameter associated with said each element;
generate programming language statements based on the contracts associated with the model-driven software architecture and its elements and the connections between the elements; and
verify the contracts associated with the model-driven software architecture and its elements using the programming language statements.

9. The data processing system of claim 8, wherein the at least one contract comprises a pre-condition and a post-condition which specify constraints to be satisfied.

10. The data processing system of claim 8, wherein the model-driven development module is configured to:
determine whether the verification of the contracts associated with the model-driven software architecture and its elements is successful; and
determine at least one contract which is violated if the verification is unsuccessful.

11. The data processing system of claim 10, wherein the model-driven development module is configured to output the model-driven software architecture with the at least one contract which is violated on a graphical user interface.

12. The data processing system of claim 11, wherein the model-driven development module is configured to modify the model-driven software architecture based on the contracts that are violated.

13. The data processing system of claim 8, wherein the model-driven development module is configured to:
parse the programming language statements;
generate a control flow graph based on the parsed programming language statements; and
determine whether any of the contracts are violated using the control flow graph.

14. The data processing system of claim 8, wherein the model-driven development module is configured to:
derive the contracts associated with the model-driven software architecture and its elements using a data dictionary, wherein the inputs, the outputs and the parameters of the elements are linked to entries in the data dictionary.

15. A non-transitory computer-readable storage medium, having instructions stored therein, which when executed by a data processing system, cause the data processing system to perform a method of verifying a model-driven software architecture in an integrated-development environment, the method comprises steps of:
generating the model-driven software architecture comprising a plurality of elements and connections between the elements, each element consists of at least one of an input, an output, and a parameter;
deriving contracts associated with the model-driven software architecture and its elements based on at least one of the input, the output, and the parameter associated with said each element;
generating programming language statements based on the contracts associated with the model-driven software architecture and its elements and the connections between the elements; and
verifying the contracts associated with the model-driven software architecture and its elements using the programming language statements.

16. The storage medium of claim 15, wherein the at least one contract comprises a pre-condition and a post-condition which specify constraints to be satisfied.

17. The storage medium of claim 15, wherein the instructions cause the data processing system to perform method steps comprising:
determining whether the verification of the contracts associated with the model-driven software architecture and its elements is successful; and
if the verification is unsuccessful, determining at least one contract which is violated.

18. The storage medium of claim 17, wherein the instructions cause the data processing system to perform a method step comprising:
outputting the model-driven software architecture with the at least one contract which is violated on the graphical user interface.

19. The storage medium of claim 18, wherein the instructions cause the data processing system to perform a method step comprising:
modifying the model-driven software architecture based on the contracts that are violated.

20. The storage medium of claim 15, wherein in verifying the contracts associated with the model-driven software architecture and its elements using the programming language statements, the instructions cause the data processing system to perform method steps comprising:
parsing the programming language statements;
generating a control flow graph based on the parsed programming language statements; and
determining whether any of the contracts are violated using the control flow graph.
